(19) United States
(12) Patent Application Publication
(10) Pub. No.: US 2024/0150915 A1
(43) Pub. Date: May 9, 2024

(54) PORTABLE HYDROGEN ELECTROLYZER INTEGRATED WITH WATER PURIFIER INDICATING LIFETIME PERCENTAGE OF PURIFICATION MATERIALS

(71) Applicant: Haiming Li, Quincy, MA (US)

(72) Inventor: Haiming Li, Quincy, MA (US)

(21) Appl. No.: 17/983,597

(22) Filed: Nov. 9, 2022

(51) Int. Cl. C25B 15/023; C25B 1/04; H01M 8/0656

(52) U.S. Cl. CPC C25B 15/023; C25B 1/04; H01M 8/0656

(57) ABSTRACT

A portable hydrogen electrolyzer integrated with water purifier indicating lifetime percentage of purification materials includes an electrolysis cell, a purification chamber, and an alterable color drying tower. A purification chamber ensures that the device can use regular water, instead of deionized water, for hydrogen production. Various configurations have been contemplated using fewer parts than other devices to decrease the risk of hydrogen leakage and improve the user experience.

### TECHNICAL FIELD

The invention relates to a portable hydrogen electrolyzer, in particular to a portable hydrogen electrolyzer with a water purifier indicating the lifetime percentage of purification materials.

### BACKGROUND AND PRIOR ART

The hydrogen fuel cell is one of the latest technologies for energy storage in daily life. Its tiny volume and longer use time (compared with fuel cell technologies, the use time can increase to weeks or months) give it a bright future. The shape and function are similar to traditional batteries but must be applied with a fuel cell for electrical power. On the other hand, the hydrogen fuel cell must be charged with a professional refueler.

The hydrogen fuel cell refueling electrolyzer must be safe and convenient for people. One of the technologies for generating hydrogen is water electrolysis. Many prior artists are attempting to design a friendly device with water electrolysis for charging the fuel cell. They focus on the theoretical structure design or complicated system.

For example, U.S. Pat. No. 7,727,647 describes a block diagram for a hydrogen fuel container refueler. A portable fuel cell refueler has a water source and an electrolyzer coupled to the water source and adapted to be connected to a power source.

U.S. Pat. No. 6,569,298 describes a complicated system containing a capacitive deionization device, water electrolysis device, and storage system.

### SUMMARY

A typical challenge in portable hydrogen electrolyzers (electrolysis technology) is that electrolysis can only use de-ionized water instead of regular (tap) water. A typical water purifier is hard to take around while you are traveling. This patent is a special design of integrating a water purification chamber inside a portable hydrogen electrolyzer with an electrolysis stack so that there is no need to carry around an inconvenient water de-ionizer/purifier.

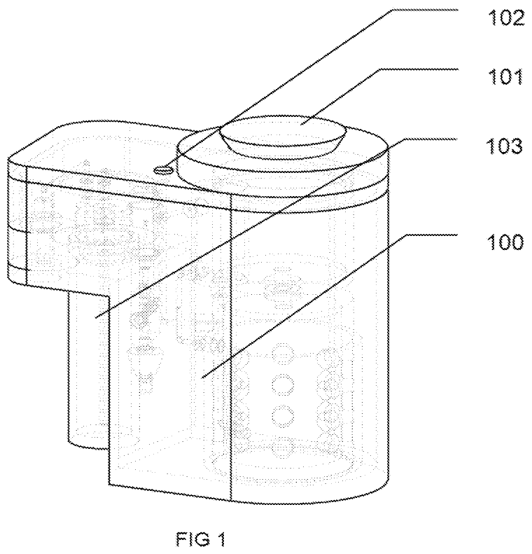

We designed the water purification chamber to be a special shape (FIG. 1) so that this device can take regular water from the inlet on the top and produce deionized water for the electrolyzer underneath. The water inlet will be sealed after each refill to prevent water from spilling during travel. The materials inside the purification chamber must be replaced if the materials' color changes. The patent also includes a design for a one-way valve between the water purification chamber and electrolysis cell, which will only allow de-ionized water to go from the chamber to the stack instead of the other way around. In order to integrate this water purification chamber into this fuel cell refueler, the different components must be highly simplified. Meanwhile, the design includes fewer parts than other hydrogen generators, so the risk of hydrogen leakage is less. For instance, the designs have only one safety valve, one pressure switch, and one gas connector, which is much simpler than the other products in the market.

Therefore, a highly efficient, safe, low-cost hydrogen fuel cell refueling electrolyzer is an effective solution for charging hydrogen batteries.

### BRIEF DESCRIPTION OF THE FIGURES

### Brief Description of the Drawings

Various embodiments will be described concerning the following accompanying drawings:

FIG. 1 is a perspective view of an example look of a portable hydrogen electrolyzer with a water purifier indicating the lifetime percentage of purification materials in accordance with one embodiment.

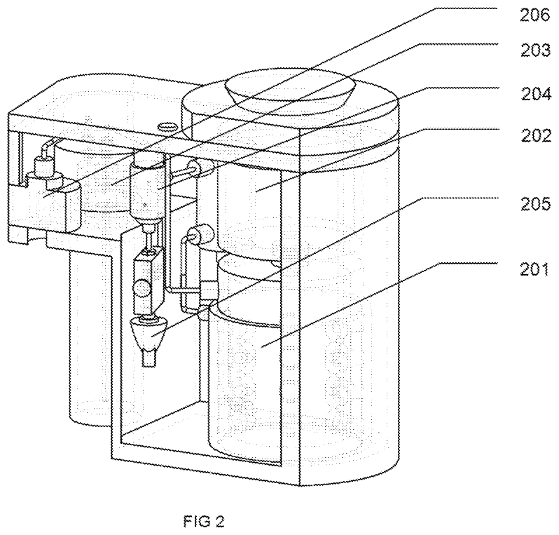

FIG. 2 is one of the cut-off views of the internal structural configuration for a portable hydrogen electrolyzer with a water purifier indicating the lifetime percentage of purification materials per one embodiment.

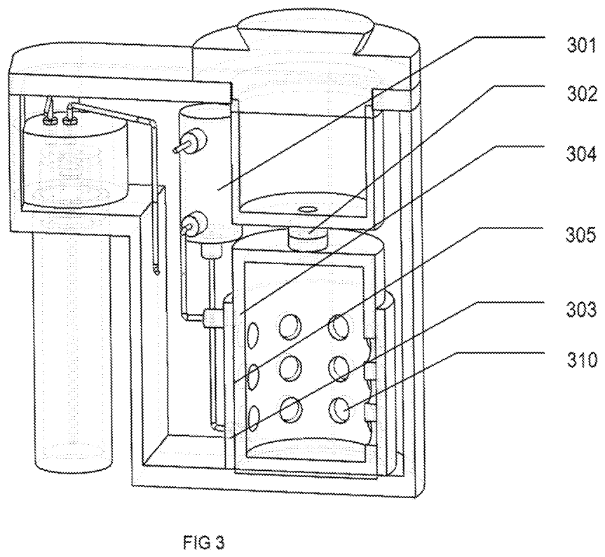

FIG. 3 is the other cut-off view of the internal structural configuration of a portable hydrogen electrolyzer with a water purifier indicating the lifetime percentage of purification materials in accordance with one embodiment.

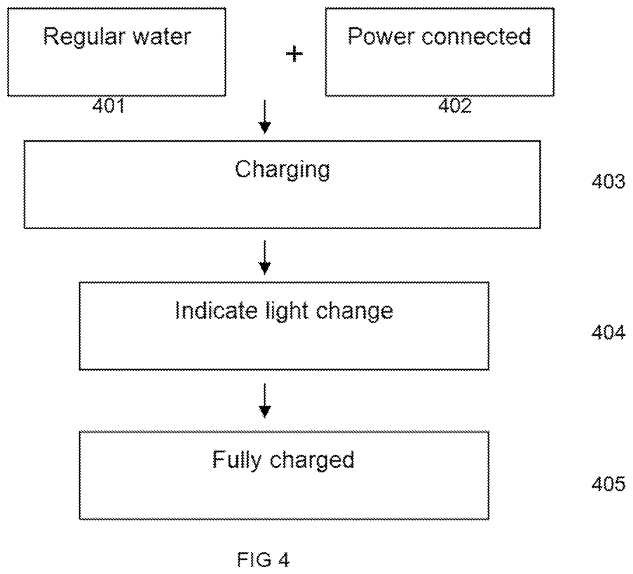

FIG. 4 is the working process for a portable hydrogen electrolyzer with a water purifier indicating the lifetime percentage of purification materials per one embodiment.

### DETAILED DESCRIPTION OF EXAMPLE EMBODIMENTS

the present application discloses a unique structural configuration of an electrolysis stack that enables adjusting the operation capacity of the electrolysis stack while ensuring the quality of the electricity connection.

Embodiments of the electrolysis stack and various components are described in detail herein. It is to be understood, however, that features described concerning one or more embodiments need not, in general, be present in all embodiments. Accordingly, the described example embodiments should be considered illustrative and not limiting.

For simplicity and clarity of illustration, the accompanying figures illustrate the general manner of construction, and description and details of well-known features and techniques may be omitted to avoid unnecessarily obscuring the invention. Additionally, elements in the figures are not necessarily drawn to scale; some areas or parts may be expanded to help improve understanding of embodiments of the invention.

The terms “first,” “second,” “third,” “fourth,” and the like in the description and the claims, if any, may be used for distinguishing between similar elements and not necessarily for describing a particular sequential or chronological order. It is to be understood that the terms so used are interchangeable. Furthermore, the terms “comprise,” “include,” “have,” and any variations thereof are intended to cover non-exclusive inclusions, such that a process, method, article, apparatus, or composition that comprises a list of elements is not necessarily limited to those elements but may include other features not expressly listed or inherent to such process, method, article, apparatus, or composition.

It is contemplated and intended that the configuration disclosed herein apply to the structure of an electrolysis stack, which can adjust its capacity to different types of electricity input; for the sake of clarity, the examples provided herein refer to either solar power or wind-generated power. Furthermore, it is contemplated and intended that the systems and methods disclosed herein may be combined with any electrolysis technology. Technologies for hydrogen generation through water electrolysis currently available and well-known to those of ordinary skill in the art include proton exchange membrane (PEM) technology and alkaline technology. PEM electrolysis is the electrolysis of water in a cell equipped with a solid polymer electrolyte (SPE) responsible for conducting protons, separating product gases, and electrical insulation of the electrodes. Alkaline electrolysis uses alkaline as the electrolyte. As will be readily appreciated, however, the embodiments described herein are not limited to these two electrolysis technologies. Still, they are also amenable to use in conjunction with other electrolysis technologies, and a person of ordinary skill in the art will know the necessary modifications and changes to be made.

FIG. 1 shows an example configuration of a portable hydrogen electrolyzer 100. The design of the portable hydrogen electrolyzer 100 is tiny in size and easily traveled by the user. The portable hydrogen electrolyzer 100 uses electricity for hydrogen generation. And a power converter (not shown in FIG. 1, 2, 3), solar panel, or others, as an accessory, is connected to the refueler 100 with a removable cable, rectifying the ac power, or the renewable power to stabilized dc power. In addition, a removable sealing cover 101 and an oxygen outlet sealing part 102 ensure the tightness of refueler 100, which allows refueler 100 to be rotated without leakage. And the drying tower 103 is to be replaced after the end of its lifetime.

The internal structure example is shown in FIG. 2 and FIG. 3, the design structure includes electrolysis cell 201, a purification chamber 202, a gas/liquid separator 301, a drying tower holder 203, one-way valve 302, safety valve 204, a pressure switch 205 and hydrogen fuel cell holder 206 (hydrogen outlet). Electrolysis cell 201 is one of the essential parts of the refueler 100, which generates hydrogen gas for storage in a hydrogen fuel cell. Electrolysis cell 201 combines cathode 303, anode 304, and membrane 305. For portable design, it is processed as a container, for example, a cylinder (in the example shown in FIG. 2 and FIG. 3), a cube, etc. Inside the electrolysis cell 201, multiple holes 310 are manufactured on the anode 304 of the cell for forming the electrolyte circuit. A one-way valve 302 connects electrolysis cell 201 and purification chamber 202. One-way valve 302 allows the liquid and gas to flow, passing itself only in one direction to guarantee the electrolyte can't flow back to purification chamber 202, chamber 202, the critical part of refueler 100, can let users directly use regular water instead of preparing deionized or distilled water, which is a very convenient way. Meanwhile, safety valve 204 and pressure switch 205 are safety precautions for people and devices. Pressure switch 205 is an electrical valve, which can shut down the power for electrolysis cell 201 when the system reaches its limitation and turns the indicating light from red to green. And the safety valve 204 is the last protection. Suppose the system's pressure is over the limit of pressure switch 204, but an electrical error occurs to pressure switch 205, and pressure keeps increasing. In that case, when it reaches the maximum pressure of safety valve 204, the high-pressure hydrogen gas can vent to the atmosphere through the safety valve.

The operational process is simplified, shown in FIG. 4, regular water 401 is the only portable hydrogen fuel cell charge resource. Add water 401 to purification chamber 202 and connect with electrical power 402 (whether from a grid or renewable power source). Meanwhile, an empty or not fully charged hydrogen storage fuel cell should be installed at hydrogen fuel cell refueling electrolyzer 206 (hydrogen outlet). Finally, turn the power on and wait for the hydrogen storage fuel cell to be charged 403, an indicating light for charging status may change from red to green 404 when it is fully charged 405.

More details can be found when we look at the inside of the portable hydrogen electrolyzer 100. The regular water 401 is purified by purification materials in purification chamber 202, becomes deionized water, and then flows into electrolysis cell 201, after that, under the electrical power, water has a chemical decomposition into hydrogen and oxygen on the cathode 303 and anode 304, respectively. Oxygen vents to the outside through an oxygen outlet, and hydrogen is pressurized, dried, and stored. The electrolyte may flow with the hydrogen to gas/liquid separator 301, then flows back and mixes with other electrolytes in electrolyte cell 201, the holes 310 on the anode are necessary for the electrolyte circuit. Replaceable drying tower 103 is installed on the drying tower holder 203, it may lose its effect when the color changes. Similarly, the purification materials in purification chamber 202 may also lose their function when their color changes after long-term use. Moreover, the lifetime of purification materials is the same as the drying tower.

As will be recognized by those skilled in the art, the innovative concepts described in the present application can be modified and varied over an extensive range of applications. Accordingly, the scope of the claimed subject matter shall not be taken as limited by any of the specific example embodiments described. It will be appreciated that various alternative modifications and variations are possible without departing from the scope of the present disclosure.

Further, none of the descriptions in the present application should be read as implying that any element, step, or function is an essential element that must be included in the claim scope. Moreover, none of the claims are intended to invoke paragraph six of 35 USC section 112 unless the exact words “means for” are followed by a participle.

What is claimed is:

1. A portable hydrogen electrolyzer integrated with water purifier indicating lifetime percentage of purification materials comprising an electrolysis cell, a water purification chamber, an alterable color drying tower, a pressure switch, and a safety valve:
the electrolysis cell dimensioned and configured to store the resource of reactions, the water purification chamber capable of purifying regular water into deionized water,
the alterable color drying tower configured to change color after absorbing enough moisture and indicate the lifetime of purification materials,
the pressure switch capable of indicating that the hydrogen batter is full or not the safety valve being connected to the electrolyzer to guarantee security.

2. The electrolyzer according to claim 1, wherein the water purification chamber has holes on the anode side configured to correct electrolyte circuit loading.

3. The electrolyzer according to claim 1, wherein the water purification chamber includes a one-way valve between the water purification chamber and the electrolysis cell, the one-way valve used to allow de-ionized water to go from the chamber to the cell, instead of the other way around.
